(19) United States
(12) Patent Application Publication
(10) Pub. No.: US 2023/0152627 A1
(43) Pub. Date: May 18, 2023

(54) BLACKLIGHT MODULE AND METHOD OF MANUFACTURING THEREOF

(71) Applicant: TCL CHINA STAR OPTOELECTRONICS TECHNOLOGY CO., LTD., Shenzhen (CN)

(72) Inventor: Kaifeng Zhou, Shenzhen (CN)

(73) Assignee: TCL CHINA STAR OPTOELECTRONICS TECHNOLOGY CO., LTD., Shenzhen (CN)

(21) Appl. No.: 17/050,110

(22) PCT Filed: Jul. 17, 2020
(86) PCT No.: PCT/CN2020/102545

§ 371 Date: Oct. 23, 2020

(30) Foreign Application Priority Data
May 19, 2020 (CN) 202010422704.3

(51) Int. Cl. G02F 1/13357; G02F 1/1333

(52) U.S. Cl. CPC G02F 1/133608; G02F 1/133314; G02F 1/133603

(57) ABSTRACT

A backlight module and a method of manufacturing thereof are provided. The backlight module includes at least one backplane assembly. Each backplane assembly includes: a first backplane, including a first binding surface; and a second backplane, including a second binding surface. Moreover, the first binding surface is attached to the second binding surface.

### CROSS REFERENCE

The present disclosure claims priority to Chinese Patent Application No. 202010422704.3, filed on May 19, 2020, filed for the invention title “blacklight module and method of manufacturing thereof”, which is hereby incorporated by reference in its entirety.

### FIELD OF INVENTION

The present disclosure relates to the technical field of display panel, and more particularly, to a method of manufacturing a blacklight module and a method of manufacturing thereof.

### BACKGROUND OF INVENTION

In recent years, mini light emitting diodes (LEDs) used as a backlight source in liquid crystal display (LCD) panels can significantly enhance the display quality, such as contrast, brightness, etc., and have attracted more and more attention from the LCD market. The backlight technology of the mini LEDs is to bind the LED chip to a backplane with a drive circuit, and use the drive circuit to control partitioned light emitting of the LEDs to achieve dynamic backlighting. The LCD is equipped with such backlight technology to achieve the display quality of thin appearance, high brightness, and ultrahigh contrast (to achieve pure black).

At present, LCD factories achieve the mini LED display technology by using the mature backplane technology to manufactures the backplane required by the mini LEDs, and then the backplanes are transported to the LED delivery factories for LED binding. Finally, the bound LED backplane is assembled into the required backlight module and equipped with a LCD panel in a corresponding size. However, a single backplane (e.g. an exposed surface of the backplane) is easily to be scratched during production (e.g. cutting) and transportation processes, which greatly affects the production yield and reliability of the backlight module. If the backplane is further packaged, the transportation costs are increased.

### SUMMARY OF INVENTION

### Technical Problems

The embodiments of the present disclosure provide a backlight module and a method of manufacturing thereof, which may prevent a binding surface of a backplane from being scratched during cutting and transportation processes, enhance the production yield and reliability of the backlight module, and reduce the transportation costs.

### Technical Solutions

One embodiment of the present disclosure provides a backlight module, which comprises at least one backplane assembly. Each backplane assembly comprises:
a first backplane, comprising a first binding surface; and a second backplane, comprising a second binding surface. The first binding surface is attached to the second binding surface.

Further, the first binding surface comprises a first light-emitting element region for binding a light-emitting element, and the second binding surface comprises a second light-emitting element region for binding the light-emitting element. An orthographic projection of the second light-emitting element region on the first binding surface completely overlaps the first light-emitting element region.

Further, a bonding glue is provided between a non-light-emitting element region of the first binding surface and a non-light-emitting element region of the second binding surface, allowing the first binding surface to be attached to the second binding surface.

Further, the bonding glue comprises any one of frame glue and hot melt glue.

Further, a spacer is disposed between the non-light-emitting element region of the first binding surface and the non-light-emitting element region of the second binding surface, allowing the first light-emitting element region of the first binding surface and the second light-emitting element region of the second binding surface to be spaced apart.

Further, the spacer comprises at least one of a support column and a spacer.

Further, a structure of the second backplane is exactly the same as a structure of the first backplane, and a cutting region is disposed between any two adjacent backplane assemblies.

One embodiment of the present disclosure further provides a method of manufacturing a backlight module, comprising steps of:
providing a first motherboard, wherein the first motherboard comprises at least one first backplane, and the first backplane comprises a first binding surface;
providing a second motherboard, wherein the second motherboard comprises at least one second backplane in one-to-one correspondence to the first motherboard, and the second backplane comprises a second binding surface;
attaching the first motherboard to the second motherboard. The first binding surface of each first backplane is attached to the second binding surface of the corresponding second backplane to form a backplane assembly.

Further, the first binding surface comprises a first light-emitting element region for binding a light-emitting element, and the second binding surface comprises a second light-emitting element region for binding the light-emitting element. An orthographic projection of the second light-emitting element region on the first binding surface completely overlaps the first light-emitting element region.

Further, a bonding glue is provided between a non-light-emitting element region of the first binding surface and a non-light-emitting element region of the second binding surface, allowing the first binding surface to be attached to the second binding surface.

Further, a spacer is disposed between the non-light-emitting element region of the first binding surface and the non-light-emitting element region of the second binding surface, allowing the first light-emitting element region of the first binding surface and the second light-emitting element region of the second binding surface to be spaced apart.

Further, the method further comprising a step of:
cutting the bonded first motherboard and second motherboard into at least one backplane assembly.

Further, the method further comprising steps of:
separating the first backplane and the second backplane of the backplane assembly;
binding a light-emitting element to the first light-emitting element region of the first backplane and the second light-emitting element region of the second backplane, respectively.

Further, the method further comprising a step of:
sequentially disposing a light guide plate and an optical film layer on the light-emitting element of the first backplane and the light-emitting element of the second backplane, respectively.

Further, the bonding glue comprises any one of frame glue and hot melt glue.

Further, the spacer comprises at least one of a support column and a spacer.

Further, a structure of the first backplane is exactly the same as a structure of the second backplane.

### Beneficial Effects

The beneficial effects of the present disclosure are that attaching the first motherboard to the second motherboard to form at least one backplane assembly may allow the first binding surface of the first backplane to attach to the second binding surface of the second backplane in each backplane assembly, which avoid damaging the binding surface during subsequent cutting and transportation processes, and enhance the production yield and reliability of the backlight module. Moreover, the transportation costs may be reduced because there is no need to package the backplane by using complex and expensive packaging methods.

### BRIEF DESCRIPTION OF DRAWINGS

The following describes the specific embodiments of the present disclosure in detail with reference to the accompanying drawings, which may allow the technical solutions and other beneficial effects of the present disclosure obvious.

FIG. 1 is a cross-sectional view of a backlight module provided by one embodiment of the present disclosure.

FIG. 2 is another cross-sectional view of the backlight module provided by one embodiment of the present disclosure.

FIG. 3 is a flow chat of a method of manufacturing a backlight module provided by one embodiment of the present disclosure.

FIGS. 4 to 7 are schematic views of the method of manufacturing the backlight module provided by one embodiment of the present disclosure.

### DETAILED DESCRIPTION OF PREFERRED EMBODIMENTS

The specific structure and detailed function disclosed herein are only illustrative, and are used for the purpose of describing exemplary embodiments of the present disclosure. However, the present disclosure can be implemented in many alternative forms, and should not be interpreted as being limited to the embodiments set forth herein.

In the present disclosure, it is appreciated that the indicated orientation or positional relationship of the terms “center,” “transverse,” “upper,” “lower,” “left,” “right,” “vertical,” “horizontal,” “top,” “bottom,” “inner,” “outer,” etc. are based on the orientation or positional relationship shown in the drawings. They are only for the convenience of describing the present disclosure and simplifying the description, rather than indicating or implying that the device or element referred to must have a specific orientation, be constructed and operated in a specific orientation, and thus cannot be interpreted as a limitation of the present disclosure. Moreover, the terms “first” and “second” are only used for descriptive purposes and cannot be interpreted as indicating or implying relative significance or implicitly indicating the amount of technical features indicated. Accordingly, the defined “first” and “second” features may comprise one or more of the technical features explicitly or implicitly. In the description of the present disclosure, “a plurality of” means two or more than two, unless otherwise specifically defined. Moreover, the term “comprising” and any transformation thereof is intended to cover non-exclusive inclusion.

In the description of the present disclosure, it should be noted that, unless otherwise clearly specified and limited, the terms “disposed,” “connected,” and “connection” should be interpreted in a broad sense. For example, it may be a fixed connection, a detachable connection, or an integral connection. It may be a mechanical connection, may also be an electrical connection, or may communicate with each other. It may be directly connected or indirectly connected through an intermediary. It may be the intercommunication between two elements or the interaction between two elements. A person ordinarily skilled in the art may understand the specific meanings of the technical terms described above in the present disclosure according to specific conditions.

The terms used herein are only for describing specific embodiments and are not intended to limit the exemplary embodiments. Unless the context clearly indicates otherwise, the singular forms “a” and “one” used herein are also intended to comprise the plural. It should also be appreciated that the terms “including” and/or “comprising” used herein specify the existence of the described features, integers, steps, operations, units and/or components, and do not exclude the existence or addition of one or more other features, integers, steps, operations, units, components, and/or combinations thereof.

The present disclosure will be further explained below in combination with the drawings and embodiments.

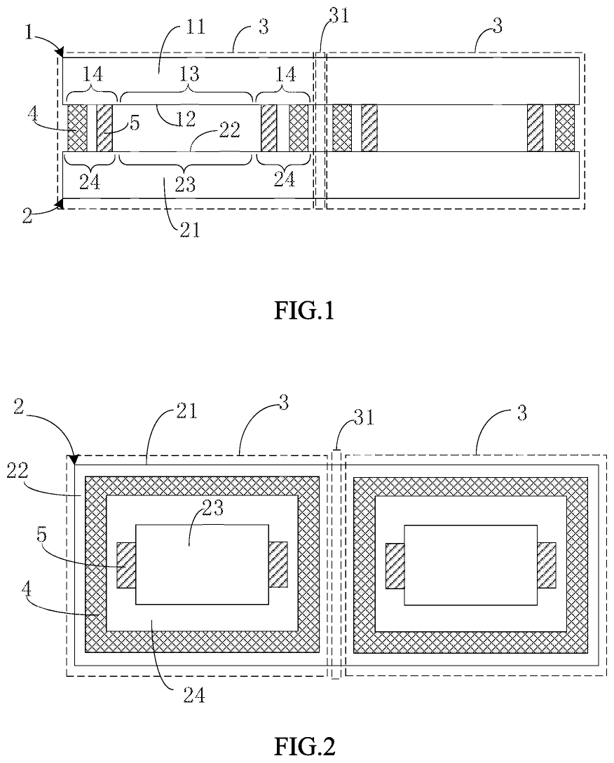

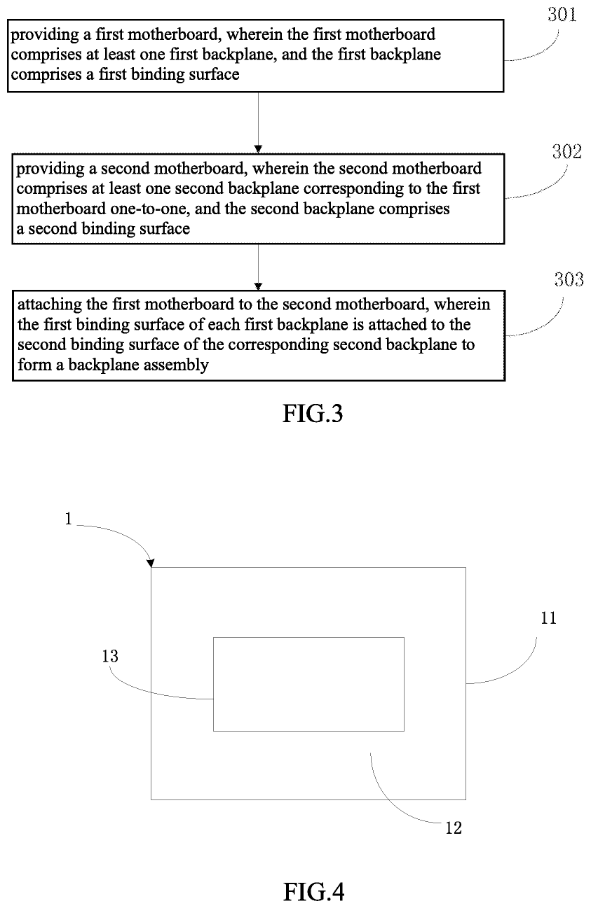

As shown in FIG. 1, one embodiment of the present disclosure provides a backlight module, which comprises a first motherboard 1 and a second motherboard 2. A structure of the first motherboard 1 may be exactly the same as a structure of the second motherboard 2. As shown in FIG. 2, the first motherboard 1 comprises at least one first backplane 11. When the first motherboard 1 comprises a plurality of first backplanes 11, the plurality of first backplanes 11 may be cut. That is, the first motherboard 1 may be cut into the plurality of first backplanes 11. The second motherboard 2 comprises at least one second backplane 21. When the second motherboard 2 comprises a plurality of second backplanes, the plurality of second backplanes 21 may be cut. That is, the second motherboard 2 may be cut into the plurality of the second backplane 21. At least one of the first backplanes 11 is in one-to-one correspondence to at least one of the second backplanes 21, and a structure of the first backplane 11 is exactly the same as the second backplane 21.

The first motherboard 1 is attached to the second motherboard 2 to form at least one backplane assembly 3, and the at least one backplane assembly 3 corresponds to the at least one first backplane 1. That is, each backplane assembly 3 respectively comprises a first backplane 11 and a second backplane 21. Wherein the first backplane 11 comprises a first binding surface 12, and the second backplane 21 comprises a second binding surface 22. The first binding surface 12 of the first backplane 11 is attached to the second binding surface 22 of the second backplane 21 in each backplane assembly 3.

Wherein, both of the first backplane 11 and the second backplane 21 may be thin film transistor (TFT) backplanes. That is, the first backplane 11 and the second backplane 21 respectively comprise a substrate (glass), and a gate, an insulation layer, an active layer, a drain, flat protective layer, and an electrode (ITO) sequentially disposed on the glass. The first backplane 11 and the second backplane 21 may be respectively used to bind light-emitting elements, such as mini LED, Micol LED, etc., to control the light-emitting elements to emit light in different regions and achieve dynamic backlight.

Since the plurality of first backplanes 11 may be cut, and the plurality of second backplanes 12 may be cut, cutting may also be performed between the backplane assemblies 3 after attaching the first motherboard 1 to the second motherboard 2. As shown in FIG. 1, a cutting region 31 may be disposed between the two adjacent backplane assemblies 3. The bonded first motherboard 1 and the second motherboard 2 may be cut into a plurality of backplane assemblies 3 by cutting the cutting region 31 to facilitate subsequent transportation. That is, the first motherboard 1 and the second motherboard 2 are transported to the next work station in the form of at least one backplane assembly 3.

In the present embodiment, the first binding surface 12 of the first backplane 11 is attached to the second binding surface 22 of the second backplane 21 to prevent the binding surface of the backplane from being exposed. In the cutting and edging processes of the backplane assembly 3, the problem of damage to the binding surface caused by the separate cutting of the conventional backplanes may be avoided. Moreover, the friction and vibration may be avoided during the transportation process, which may cause the damage of the binding surface of the backplane, so as to subsequently bind the light-emitting elements onto the binding surface without damage, thereby enhancing the production yield and reliability of the backlight module. In addition, the first backplane 11 and the second backplane 12 are used to protect the binding surfaces of each other, and additional complex and expensive packaging methods to package the backplanes are not needed, thereby reducing the transportation costs.

Further, as shown in FIG. 1, the first binding surface 12 comprises a first light-emitting element region 13 for binding light-emitting elements, and the second binding surface 22 comprises a second light-emitting element region 23 for binding light-emitting elements.

Since a structure of the first backplane 11 and a structure of the second backplane 21 may be exactly the same, a position and size of the first light-emitting element region 13 on the first binding surface 12 is the same as a position and size of the second light-emitting element region 23 on the second binding surface 22 may be exactly the same. After attaching the first backplane 11 to the corresponding second backplane 21 to form a backplane assembly, an orthographic projection of the second backplane 21 projected on the corresponding first backplane 11 completely overlaps the corresponding first backplane 11, and an orthographic projection of the second light-emitting element region 23 of the second binding surface 22 projected on the corresponding first binding surface 12 completely overlaps the first light-emitting element region 13 of the corresponding first binding surface 12. That is, the first backplane 11 is disposed opposite the corresponding second backplane 21, and the first light-emitting element region 13 is disposed opposite the corresponding second light-emitting element region 23. Moreover, a gap may be disposed between the first light-emitting element region 13 and the second light-emitting element region 23 to prevent the binding surface of the first light-emitting element region 13 and the binding surface of the second light-emitting element region 23 from being damaged due to mutual friction during the transportation process.

Specifically, the first binding surface 12 may also comprise a non-light-emitting element region 14 located outside the first light-emitting element region 13. For example, the non-light-emitting element region 14 is located around the first light-emitting element region 13. The second binding surface 22 may also comprise a non-light-emitting element region 24 located outside the second light-emitting element region 23. For example, the non-light-emitting element region 24 is located around the second light-emitting element region 23. An orthographic projection of the non-emitting element region 24 of the second binding surface 22 projected on the corresponding first binding surface 12 completely overlaps the non-emitting element region 14 of the corresponding first binding surface 12. That is, the non-light-emitting element region 14 of the first binding surface 12 is disposed opposite the corresponding non-light-emitting element region 24 of the second binding surface 22.

A bonding glue 4 is provided between the non-light-emitting element region 14 of the first binding surface 12 and the non-light-emitting element region 24 of the corresponding second binding surface 22, and the bonding glue 4 may be disposed surrounding a periphery of the first light-emitting element region 13 or a periphery of the second light-emitting element region 23. The non-light-emitting element region 14 of the first binding surface 12 is attached to the corresponding non-light-emitting element region 24 of the second binding surface 22 by the bonding glue 4, thereby achieving the bonding of the first binding surface 12 and the corresponding second binding surface 22. That is, the first backplane 11 is adhered to the corresponding second backplane 21. The bonding glue 4 may be bonded or separated under certain heat or light conditions. For example, the bonding glue 4 may comprise any one of frame glue and hot melt glue. If the bonding glue 4 is the frame glue, only the frame glue is pre-cured (UV curing) during bonding. The hot melt glue has strong adhesive force at room temperature. The adhesive melts into a liquid state when the hot melt glue is heated above 100° C., and the adhesive force is 0, which may achieve the subsequent separation of the backplane.

In the present embodiment, the bonding glue 4 is provided between the non-light-emitting element region 14 of the first binding surface 12 and the corresponding non-light-emitting element region 24 of the second binding surface 22. That is, only the non-light-emitting element regions of the two binding surfaces are attached, and the bonding glue 4 is not provided between the light-emitting element regions of the two binding surfaces, which may prevent the two binding surfaces from damaging the binding surface in the light-emitting element region during bonding and subsequent separation processes. Moreover, it prevents the bonding glue 4 remaining in the light-emitting element region after subsequent separation process, which affects the subsequent binding of the light-emitting element. In addition, due to the disposition of the bonding glue 4, a certain gap is present between the light-emitting element regions of the two binding surfaces, which prevents the binding surfaces of the two light-emitting element regions from being damaged due to mutual friction during the transportation process.

Specifically, a spacer 5 may also be disposed between the non-light-emitting element region 14 of the first binding surface 12 and the corresponding non-light-emitting element region 24 of the second binding surface 22. That is, one end of the spacer 5 abuts against the non-emitting element region 14 of the first binding surface 12, and the other end of the spacer 5 abuts against the non-emitting element region 24 of the second binding surface 22, which allows the spacer 5 to be supported between the two backplanes, so that the first light-emitting element region 13 of the first binding surface 12 is spaced apart from the corresponding second light-emitting element region 23 of the second binding surface 22. The spacer 5 comprises at least one of a support column and a spacer.

In the present embodiment, the spacer 5 is disposed between the two non-light-emitting element regions to further increase the gap between the binding surfaces of the two light-emitting element regions. In addition, no any spacer 5 is disposed between the light-emitting element regions of the two binding surfaces to avoid friction between the spacer 5 and the binding surfaces of the two light-emitting element regions, which may damage the binding surfaces of the two light-emitting element regions.

It should be noted that after the backplane assembly 3 is transported to the next station, the first backplane 11 and the second backplane 21 in the backplane assembly 3 are separated by heating or laser peeling, and then the first light-emitting element region 13 of the separated first backplane 11 and the second light-emitting element region 23 of the separated second backplane 2 are respectively bound with light-emitting elements, where the light-emitting elements include, but are not limited to, mini LED and Micro LED. After the light-emitting elements are bound to the backplanes, a light guide plate, and an optical film layer, etc. may be further disposed to form a complete backlight module. A display panel may be disposed on the backlight module to form a display device.

In summary, the embodiments of the present disclosure provide the technique that bonding the first motherboard and the second motherboard to form the at least one backplane assembly allows the first binding surface of the first backplane to be attached to the binding surface of the second backplane in each backplane assembly to protect the binding surfaces of the first backplane and the second backplane, thereby avoiding damage to the binding surfaces during subsequent cutting and transportation processes, and enhancing the production yield and reliability of the backlight module. Moreover, there is no need to use complex and expensive packaging methods to package the backplane, thereby reducing the transportation costs.

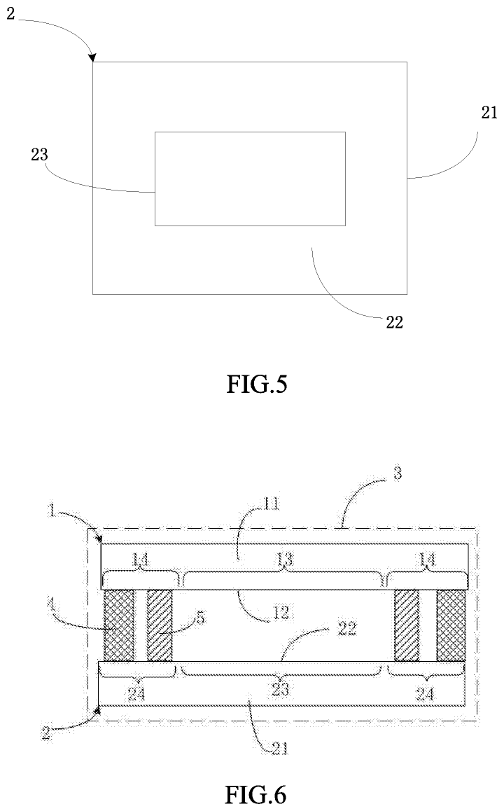

As shown in FIG. 3, one embodiment of the present disclosure also provides a method of manufacturing a backlight module, which comprises follow steps:

301: providing a first motherboard. The first motherboard comprises at least one first backplane, and the first backplane comprises a first binding surface.

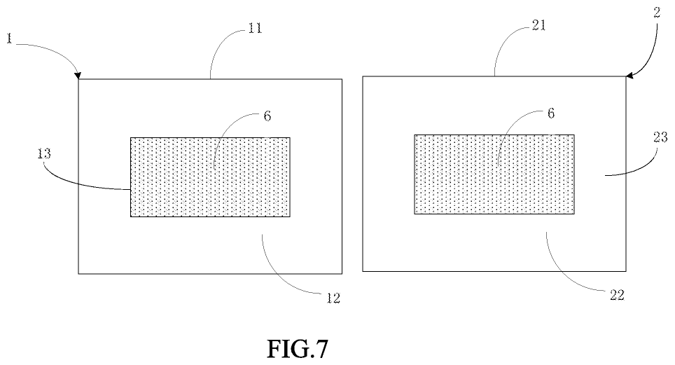

For example, as shown in FIG. 4, the first motherboard 1 comprises a first backplane 11. When the first motherboard 1 comprises a plurality of first backplanes 11, the first motherboard 1 may be cut into the plurality of first backplanes 11. Each first backplane 11 comprises a first binding surface 12, and the first binding surface 12 comprises a first light-emitting element region 13 for binding light-emitting elements.

Wherein, each first backplane 11 of the first motherboard 1 may be a TFT backplane. A method of manufacturing each first backplane 11 may comprise: sequentially depositing a gate, an insulation layer, an active layer, a drain, flat protective layer, and an electrode (ITO) on a substrate (glass), and allows each layer to form specific patterns as needed by a yellow light process.

302: Providing a second motherboard. The second motherboard comprises at least one second backplane in one-to-one correspondence to the first motherboard. The second backplane comprises a second binding surface.

For example, as shown in FIG. 5, the second motherboard 2 comprises a second backplane 21. When the second motherboard 2 comprises a plurality of second backplanes 21, the second motherboard 2 may be cut into the plurality of second backplanes 21. Each second backplane 21 comprises a second binding surface 22. The second binding surface 22 comprises a second light-emitting element region 23 for binding light-emitting elements.

Wherein, each second backplane 21 of the second motherboard 2 may be a TFT backplane. A method of manufacturing each first backplane 21 may comprise: sequentially depositing a gate, an insulation layer, an active layer, a drain, flat protective layer, and an electrode (ITO) on a substrate (glass), and allows each layer to form specific patterns as needed by a yellow light process.

A structure of the first motherboard 1 may be exactly the same as a structure of the second motherboard 2. That is, the first backplane 11 is disposed opposite the second backplane 21, and a structure of the first backplane 11 may be exactly the same as a structure of the second backplane 21. A position and size of the first light-emitting element region 13 on the first binding surface 12 is the same as a position and size of the second light-emitting element region 23 on the second binding surface 22.

303: Attaching the first motherboard to the second motherboard. The first binding surface of each first backplane is attached to the second binding surface of the corresponding second backplane to form a backplane assembly.

For example, as shown in FIG. 6, the first motherboard 1 is attached to the second motherboard 2 in an atmospheric environment to form a backplane assembly 3. That is, the backplane assembly 3 comprises a first backplane 11 and a second backplane 21, and the first binding surface 12 of the first backplane 11 is attached to the second binding surface 22 of the second backplane 21.

After attaching the first backplane 11 to the corresponding second backplane 21 to form the backplane assembly, an orthographic projection of the second backplane 21 projected on the corresponding first backplane 11 completely overlaps the corresponding first backplane 11. An orthographic projection of the second light-emitting element region 23 of the second binding surface 22 projected on the corresponding first binding surface 12 completely overlaps the first light-emitting element region 13 of the corresponding first binding surface 12.

Specifically, a bonding glue 4 is provided between the non-light-emitting element region 14 of the first binding surface 12 and the non-light-emitting element region 24 of the corresponding second binding surface 22, and the bonding glue 4 may be disposed surrounding a periphery of the first light-emitting element region 13 or a periphery of the second light-emitting element region 23. The non-light-emitting element region 14 of the first binding surface 12 is attached to the corresponding non-light-emitting element region 24 of the second binding surface 22 by the bonding glue 4, thereby achieving the bonding of the first binding surface 12 and the corresponding second binding surface 22. That is, the first backplane 11 is adhered to the corresponding second backplane 21. The bonding glue 4 may comprise any one of frame glue and hot melt glue.

Specifically, a spacer 5 may also be disposed between the non-light-emitting element region 14 of the first binding surface 12 and the corresponding non-light-emitting element region 24 of the second binding surface 22. That is, one end of the spacer 5 abuts against the non-emitting element region 14 of the first binding surface 12, and the other end of the spacer 5 abuts against the non-emitting element region 24 of the second binding surface 22, which allows the spacer 5 to be supported between the two backplanes, so that the first light-emitting element region 13 of the first binding surface 12 is spaced apart from the corresponding second light-emitting element region 23 of the second binding surface 22. The spacer 5 comprises at least one of a support column and a spacer.

Further, the method further comprises: a step of cutting the bonded first motherboard and second motherboard into at least one backplane assembly.

As shown in FIG. 1, the bonded first motherboard 1 and the second motherboard 2 comprise a plurality of backplane assemblies 3. A cutting region 31 may be disposed between the two adjacent backplane assemblies 3. The bonded first motherboard 1 and the second motherboard 2 may be cut into a plurality of backplane assemblies 3 by cutting in the cutting region 31. Cutting is processed after bonding the first motherboard 1 and the second motherboard 2, which may avoid damage to the binding surface of the light-emitting element region when the first motherboard 1 and the second motherboard 2 are cut separately. In addition, the transportation is carried out in the form of the backplane assembly 3, which may enhance the convenience of transportation and avoids damage to the binding surface of the light-emitting element region during the transportation process.

Further, the method further comprises steps of:
separating the first backplane and the second backplane of the backplane assembly;
binding a light-emitting element to the first light-emitting element region of the first backplane and the second light-emitting element region of the second backplane, respectively.

For example, as shown in FIG. 7, after the backplane assembly 3 is transported to the next work station, the first backplane 11 of the backplane assembly 3 is separated from the second backplane 21 by heating (such as 120° C., 20 minutes) or laser peeling, and then the light-emitting elements 6 are bound to the first light-emitting element region 13 of the first backplane 11 and the second light-emitting element region 23 of the second backplane 2 after separation. Among them, the light-emitting elements 6 include, but are not limited to, mini LED and Micro LED. After the light-emitting elements 6 are bound to the backplanes, a light guide plate, and an optical film layer, etc. may be further disposed to form a complete backlight module. A display panel may be disposed on the backlight module to form a display device.

The embodiments of the present disclosure provide the technique that bonding the first motherboard and the second motherboard to form the at least one backplane assembly allows the first binding surface of the first backplane to be attached to the binding surface of the second backplane in each backplane assembly to protect the binding surfaces of the first backplane and the second backplane, thereby avoiding damage to the binding surfaces during subsequent cutting and transportation processes, and enhancing the production yield and reliability of the backlight module. Moreover, there is no need to use complex and expensive packaging methods to package the backplane, thereby reducing the transportation costs.

In summary, although the present disclosure has been disclosed as above in preferred embodiments, the above-mentioned preferred embodiments are not intended to limit the present disclosure. A person ordinarily skilled in the art can make various changes and modifications without departing from the concept and scope of the present disclosure. Therefore, the claimed scope of the present disclosure based on the scope defined by the claims.

What is claimed is:

1. A backlight module, comprising at least one backplane assembly, wherein each backplane assembly comprises:
a first backplane, comprising a first binding surface; and
a second backplane, comprising a second binding surface;
wherein, the first binding surface is attached to the second binding surface.

2. The backlight module according to claim 1, wherein the first binding surface comprises a first light-emitting element region for binding a light-emitting element, and the second binding surface comprises a second light-emitting element region for binding the light-emitting element;
an orthographic projection of the second light-emitting element region on the first binding surface completely overlaps the first light-emitting element region.

3. The backlight module according to claim 2, wherein a bonding glue is provided between a non-light-emitting element region of the first binding surface and a non-light-emitting element region of the second binding surface, allowing the first binding surface to be attached to the second binding surface.

4. The backlight module according to claim 3, wherein the bonding glue comprises any one of frame glue and hot melt glue.

5. The backlight module according to claim 2, wherein a spacer is disposed between the non-light-emitting element region of the first binding surface and the non-light-emitting element region of the second binding surface, allowing the first light-emitting element region of the first binding surface and the second light-emitting element region of the second binding surface to be spaced apart.

6. The backlight module according to claim 4, wherein the spacer comprises at least one of a support column and a spacer.

7. The backlight module according to claim 1, wherein a structure of the second backplane is exactly the same as a structure of the first backplane, and a cutting region is disposed between any two adjacent backplane assemblies.

8. A method of manufacturing a backlight module, comprising steps of:
providing a first motherboard, wherein the first motherboard comprises at least one first backplane, and the first backplane comprises a first binding surface;
providing a second motherboard, wherein the second motherboard comprises at least one second backplane in one-to-one correspondence to the first motherboard, and the second backplane comprises a second binding surface;
attaching the first motherboard to the second motherboard, wherein the first binding surface of each first backplane is attached to the second binding surface of the corresponding second backplane to form a backplane assembly.

9. The method of manufacturing the backlight module according to claim 8, wherein the first binding surface comprises a first light-emitting element region for binding a light-emitting element, and the second binding surface comprises a second light-emitting element region for binding the light-emitting element;
an orthographic projection of the second light-emitting element region on the first binding surface completely overlaps the first light-emitting element region.

10. The method of manufacturing the backlight module according to claim 9, wherein a bonding glue is provided between a non-light-emitting element region of the first binding surface and a non-light-emitting element region of the second binding surface, allowing the first binding surface to be attached to the second binding surface.

11. The method of manufacturing the backlight module according to claim 9, wherein a spacer is disposed between the non-light-emitting element region of the first binding surface and the non-light-emitting element region of the second binding surface, allowing the first light-emitting element region of the first binding surface and the second light-emitting element region of the second binding surface to be spaced apart.

12. The method of manufacturing the backlight module according to claim 8, wherein the method further comprising a step of:
cutting the bonded first motherboard and second motherboard into at least one backplane assembly.

13. The method of manufacturing the backlight module according to claim 12, wherein the method further comprising steps of:
separating the first backplane and the second backplane of the backplane assembly;
binding a light-emitting element to the first light-emitting element region of the first backplane and the second light-emitting element region of the second backplane, respectively.

14. The method of manufacturing the backlight module according to claim 13, wherein the method further comprising a step of:
sequentially disposing a light guide plate and an optical film layer on the light-emitting element of the first backplane and the light-emitting element of the second backplane, respectively.

15. The method of manufacturing the backlight module according to claim 10, wherein the bonding glue comprises any one of frame glue and hot melt glue.

16. The method of manufacturing the backlight module according to claim 11, wherein the spacer comprises at least one of a support column and a spacer.

17. The method of manufacturing the backlight module according to claim 8, wherein a structure of the first backplane is exactly the same as a structure of the second backplane.
